(19) United States
(12) Patent Application Publication
(10) Pub. No.: US 2026/0211793 A1
(43) Pub. Date: Jul. 23, 2026

(54) COMPUTATIONAL GOVERNANCE USING METADATA-AS-CODE

(71) Applicant: Dell Products L.P., Round Rock, TX (US)

(72) Inventors: Marcos Vinicius de Oliveira, Calgary (CA); Yijing Zhou, Austin, TX (US); Jahangeer Pasha Mohammed, Milton (CA)

(21) Appl. No.: 19/030,449

(22) Filed: Jan. 17, 2025

(51) Int. Cl. G06F 11/3604

(52) U.S. Cl. CPC G06F 11/3608

(57) ABSTRACT

Methods, apparatus, and processor-readable storage media for computational governance using metadata code are provided herein. An example computer-implemented method includes obtaining metadata in a code format for at least one data asset, where the metadata includes information related to one or more characteristics of the at least one data asset. The method includes processing the obtained metadata using at least one data pipeline, where the at least one data pipeline executes at least one validation process for automatically validating the obtained metadata based on one or more data validation rules. The method further includes automatically deploying, based at least in part on the code format, the obtained metadata to at least one computing environment in response to at least one designated result of the at least one validation process.

### BACKGROUND

Computational governance generally refers to the use of software code and algorithms to automate, standardize and improve the transparency of decision-making and rule enforcement in organizations and systems.

### SUMMARY

Illustrative embodiments of the disclosure provide techniques for computational governance using metadata-as-code. An exemplary computer-implemented method includes obtaining metadata in a code format for at least one data asset, where the metadata includes information related to one or more characteristics of the at least one data asset. The method includes processing the obtained metadata using at least one data pipeline, where the at least one data pipeline executes at least one validation process for automatically validating the obtained metadata based on one or more data validation rules. The method further includes automatically deploying, based at least in part on the code format, the obtained metadata to at least one computing environment in response to at least one designated result of the at least one validation process.

Illustrative embodiments can provide significant advantages relative to conventional techniques. For example, technical problems associated with inefficient and/or inconsistent data governance are mitigated in one or more embodiments by leveraging metadata in a code format and one or more data pipeline validation processes. Such embodiments can effectively improve scalability, consistency and efficiency of computational governance across multiple environments.

These and other illustrative embodiments described herein include, without limitation, methods, apparatus, systems and computer program products comprising processor-readable storage media.

### BRIEF DESCRIPTION OF THE DRAWINGS

FIG. 1 shows an information processing system configured for computational governance using metadata-as-code in an illustrative embodiment.

FIG. 2 shows an example of a system architecture for computational governance using metadata-as-code in an illustrative embodiment.

FIG. 3 shows an example of a processing pipeline in an illustrative embodiment.

FIG. 4 shows an example of a metadata-as-code file in an illustrative embodiment.

FIG. 5 shows a flow diagram of a process for computational governance using metadata-as-code in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Centralized and federated governance are two types of data governance models. Centralized governance (also referred to as “centralized data governance”) refers to a model where data management and governance policies are controlled by a central authority within an organization. A centralized governance approach ensures uniformity and consistency in data standards, policies, and procedures across the entire organization, and also allows for streamlined decision-making, easier compliance with regulations, and a single source of truth for data. However, centralized governance models can often lead to bottlenecks and reduced flexibility for individual departments, groups, or teams within the organization. Federated governance (also referred to as “federated data governance”), on the other hand, distributes data governance responsibilities across various departments or business units within the organization. Each unit has the autonomy to manage its own data according to overarching governance policies and standards set by a central body, for example. A federated governance model promotes flexibility, allowing departments to tailor data management practices to their specific needs while still adhering to common guidelines. It can enhance agility and responsiveness, but can also pose challenges in maintaining consistency and control across the organization.

The term “computational governance” (also referred to as “computational data governance”) as used herein generally refers to a framework and/or processes for ensuring proper management, quality and security of data within an organization. For example, computational governance can include designing one or more standards and/or practices to effectively manage data assets and ensure data integrity, availability, and confidentiality. In some embodiments, computational governance integrates computational techniques and tools to automate data management tasks, enhance data quality, and enforce compliance with designated requirements (e.g., regulatory requirements).

The exponential growth of data, particularly with the rise of generative artificial intelligence, presents various technical challenges for traditional data architectures. Centralized data architectures, including data warehouses, data lakes and data lakehouses, along with centralized governance models, are insufficient to keep up with the amount of data being generated. As a result, there has been a significant shift from centralized governance towards federated governance. However, federated governance also presents technical challenges. For example, federated governance makes it difficult to enforce the standards consistently as every domain or function may have its own business goals, priorities and incentives. Federated computational governance also remains difficult to scale given the speed at which new data is generated.

Some embodiments described herein provide computational governance techniques that combine metadata-as-code with data pipelines comprising pipeline validators that can be applied to centralized governance and/or federated governance models. Such embodiments can improve the scalability, efficiency, effectiveness and consistency of centralized governance and/or federated governance models relative to conventional approaches.

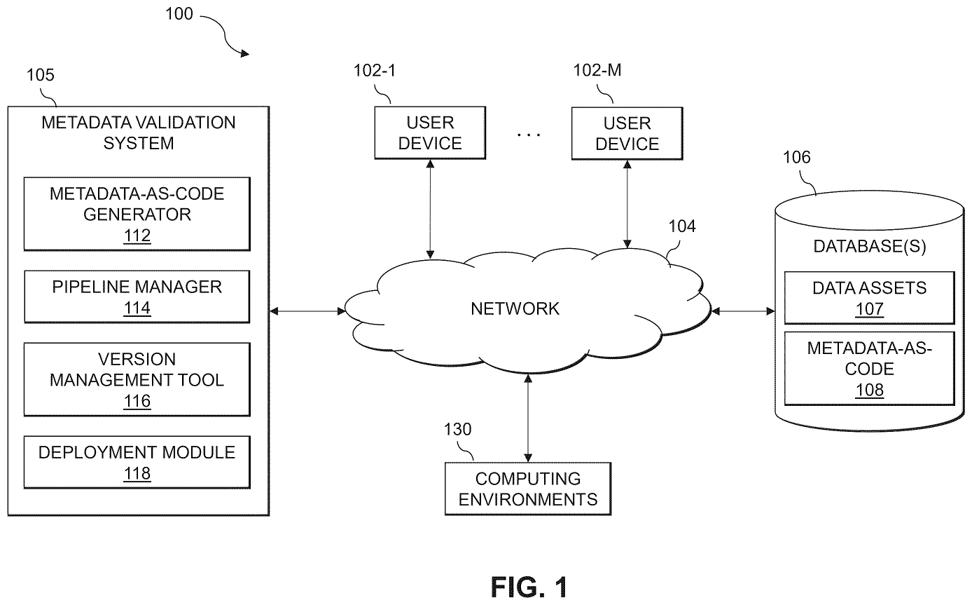

FIG. 1 shows a computer network (also referred to herein as an information processing system) 100 configured in accordance with an illustrative embodiment. The computer network 100 comprises a plurality of user devices 102-1,. 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a metadata validation system 105 and one or more computing environments 130.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 and/or the metadata validation system 105 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

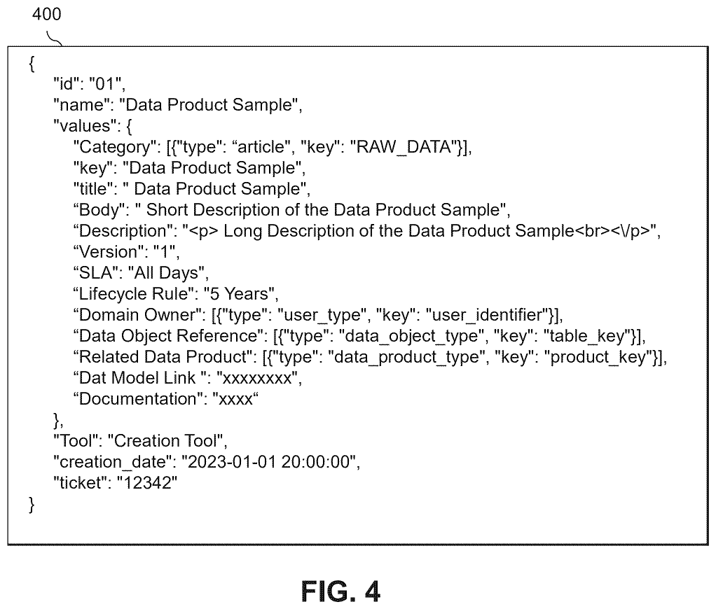

The metadata validation system 105 can have at least one associated database 106 configured to store data pertaining to, for example, one or more data assets 107 and/or metadata-as-code 108. The term “data asset” as used in this context and elsewhere herein is intended to be broadly construed so as to encompass various types of data and/or data products such as software applications, data science algorithms, software tools and datasets (e.g., training datasets, raw datasets and/or structured datasets), as non-limiting examples. The term “metadata-as-code” as used in this context and elsewhere herein is intended to be broadly construed so as to encompass metadata that is stored in a machine-readable format (sometimes referred to herein as metadata in a code format) so that metadata can be defined and managed, possibly in a version-controlled environment. The use of metadata-as-code can improve automation, consistency and/or collaboration in managing metadata. As a non-limiting example, the metadata-as-code 108 may include one or more metadata-as-code files corresponding to the one or more data assets 107. An example of a metadata-as-code file is described in more detail in conjunction with FIG. 4.

An example database 106, such as depicted in the present embodiment, can be implemented using one or more storage systems associated with the metadata validation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the metadata validation system 105 are one or more input-output devices, which illustratively comprise keyboards, displays or other types of input-output devices in any combination. Such input-output devices can be used, for example, to support one or more user interfaces to the metadata validation system 105, as well as to support communication between metadata validation system 105, the user device 102, the computing environments 130 and/or other related systems and devices not explicitly shown.

Additionally, the metadata validation system 105 in the FIG. 1 embodiment is assumed to be implemented using at least one processing device. Each such processing device generally comprises at least one processor and an associated memory, and implements one or more functional modules for controlling certain features of the metadata validation system 105.

More particularly, the metadata validation system 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the metadata validation system 105 to communicate over the network 104 with the user devices 102, and illustratively comprises one or more conventional transceivers.

The metadata validation system 105 further comprises a metadata-as-code generator 112, a pipeline manager 114, a version management tool 116 and a deployment module 118.

In some embodiments, the metadata-as-code generator 112 generates one or more metadata-as-code files, which, in some examples, are stored in the at least one database 106 as metadata-as-code 108. For example, the metadata-as-code generator 112 can generate the one or more metadata-as-code files using one or more scripts to extract the metadata corresponding to a given one of the data assets 107. Alternatively, or additionally, the metadata-as-code generator 112 can utilize one or more machine learning techniques to generate or extract at least portions of the metadata.

The pipeline manager 114 is configured to initiate one or more data pipelines comprising one or more validators for validating the metadata-as-code 108. For example, a given one of the pipeline validators can validate the metadata-as-code 108 corresponding to one or more of the data assets 107 based on one or more data validation policies and/or rules related to, for example, security classification, architecture standards, data models, data quality rules, lineage and/or ownership, as non-limiting examples. In some embodiments, the data validation policies and/or rules for at least some of the pipeline validators can correspond to one or more data governance rules and/or policies and can be configured depending on the use case.

The version management tool 116 generally comprises functionality for tracking changes to files, software code or documents over time. The version management tool 116 enables users (e.g., associated with the one or more of the user devices 102) to manage, maintain and/or synchronize multiple versions of files, ensuring consistency and collaboration across users, projects and/or organizations. The version management tool 116 can be used to track multiple versions of the metadata-as-code 108, for example.

The deployment module 118 is configured to automatically deploy metadata-as-code 108 to the one or more computing environments 130. For example, the metadata-as-code 108 corresponding to a given data asset 107 can be deployed to one of the computing environments 130 (e.g., a production computing environment) following validation by the metadata validation system 105.

In at least one embodiment, the metadata validation system 105 can comprise, or be integrated into, a continuous improvement/continuous delivery (CI/CD) platform. A CI/CD platform generally corresponds to a set of development tools, processes and practices designed to automate software development lifecycles. As a non-limiting example, a CI/CD platform may include functionality for: pipeline automation for creating and managing workflows for building, testing and deploying software code; integrating with development tools, testing frameworks and/or deployment tools; incorporating security tools for code scanning, vulnerability checks and compliance; and providing insights into the status of data pipelines, deployments and system performance.

It is to be appreciated that this particular arrangement of elements 112, 114, 116 and 118 illustrated in the metadata validation system 105 of the FIG. 1 embodiment is presented by way of example only, and alternative arrangements can be used in other embodiments. For example, the functionality associated with the elements 112, 114, 116 and 118 in other embodiments can be combined into a single module, or separated across a larger number of modules. As another example, multiple distinct processors can be used to implement different ones of the elements 112, 114, 116 and 118 or portions thereof.

At least portions of elements 112, 114, 116 and 118 may be implemented at least in part in the form of software that is stored in memory and executed by a processor.

It is to be appreciated that in other embodiments, at least portions of the metadata validation system 105 can be implemented on one or more of the user devices 102 and/or one or more of the computing platforms 120.

It is to be understood that the particular set of elements shown in FIG. 1 for metadata validation system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the metadata validation system 105 and database(s) 106 can be on and/or part of the same processing platform.

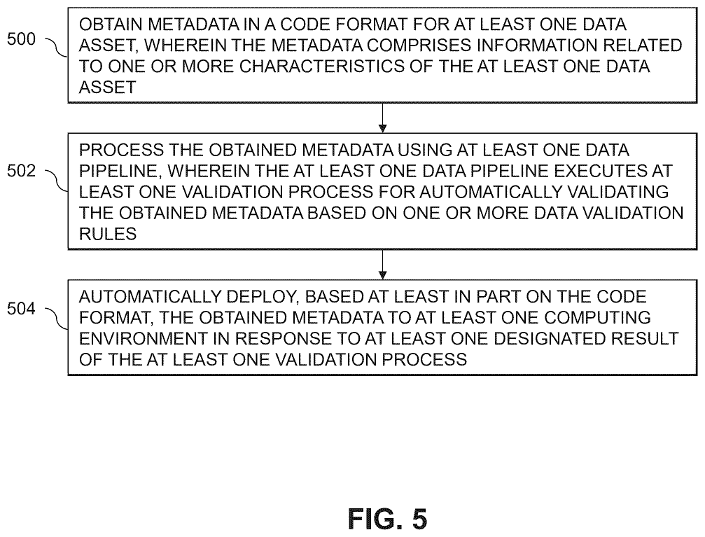

An exemplary process utilizing modules elements 112, 114, 116 and 118 of an example metadata validation system 105 in computer network 100 will be described in more detail with reference to, for example, the flow diagram of FIG. 5.

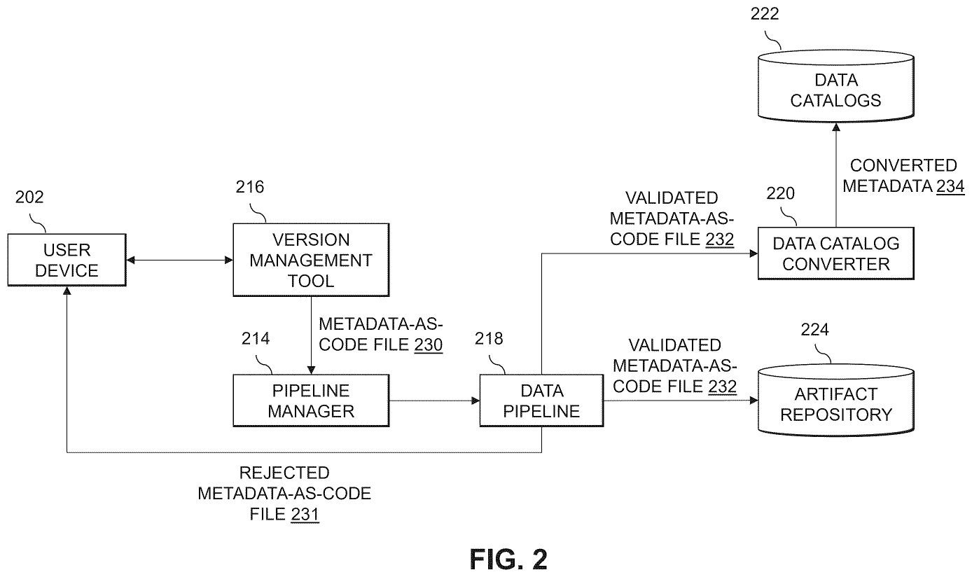

FIG. 2 shows an example of a system architecture for computational governance using metadata-as-code in an illustrative embodiment. The system architecture includes a user device 202, a version management tool 216, a pipeline manager 214, a data pipeline 218, a data catalog converter 220, one or more data catalogs 222 and an artifact repository 224.

It is assumed that the version management tool 216 manages different versions of metadata-as-code files. The version management tool 216 is configured to manage different versions of metadata-as-code files (e.g., corresponding to one or more of the data assets 107) and track changes made to these files over time. For example, the user device 202 may interact with the version management tool 216 to define, modify and/or deploy the metadata-as-code files.

In this example, it is assumed that a metadata-as-code file 230 is selected to be validated and deployed to at least one of the one or more data catalogs 222. In response to being selected, the metadata-as-code file 230 is provided to the pipeline manager 214 to initiate a data pipeline 218.

In some embodiments, one or more deployments (or redeployments) to certain types of computing environments (e.g., production environments) may require approval from at least one designated user. Once approved, the data pipeline 218 can be executed repeatedly for the production environment.

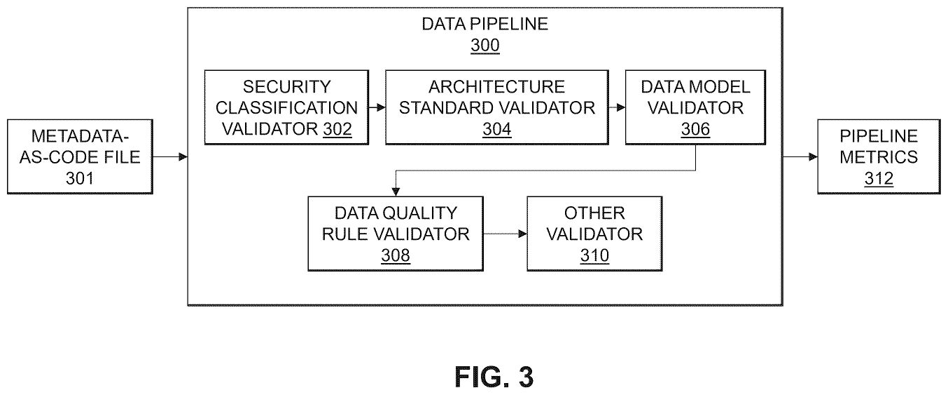

The pipeline manager 214 initiates the data pipeline 218, which includes one or more validators configured to validate the metadata-as-code file 230 against one or more data validation policies and/or rules. Each validator in the data pipeline 218 outputs a result indicating whether the metadata-as-code file 230 satisfies the one or more data validation policies and/or rules. An example of a pipeline including data validators is explained in more detail in conjunction with FIG. 3.

If the metadata-as-code file 230 is successfully validated by the data pipeline 218, then the validated metadata-as-code file 232 can be stored in the artifact repository 224 as a validated metadata-as-code file 232, possibly along with one or more other versions of the validated metadata-as-code file 232.

In some embodiments, the validated metadata-as-code file 232 is provided as input to the data catalog converter 220. As a non-limiting example, if the data catalogs 222 comprise a first data catalog that requires metadata to be in a first format and a second data catalog that requires metadata to be in a second format, then the data catalog converter 220 can process the validated metadata-as-code file 232 (e.g., using one or more scripts) so that the metadata can be deployed to the first data catalog in the first format and deployed to the second data catalog in the second format. Accordingly, the one or more data catalogs 222 can store descriptive information about various data assets based on the information in metadata-as-code files that have been validated.

If the metadata-as-code file 230 fails validation, it is returned to the user device 202 as a rejected metadata-as-code file 231. In some embodiments, information related to why the rejection occurred can also be provided to the user device 202. The information may include, for example, an explanation of which specific validation rules or policies were not met.

For example, consider a scenario where one of the validators is configured to check for compliance with one or more payment card standards. If the validator processes the metadata-as-code file 230 and detects that credit card numbers are stored in plaintext, it can trigger an alert sent back to the user device 202 along with information explaining why the metadata-as-code file 230 was rejected, which could indicate that credit card numbers must not be stored in plaintext.

FIG. 3 shows an example of a data pipeline 300 in an illustrative embodiment. In this example, the data pipeline 300 includes multiple validators 302 through 310 configured to validate metadata-as-code against various governance policies and rules. Specifically, the data pipeline 300 comprises a security classification validator 302, an architecture standard validator 304, a data model validator 306, a data quality rule validator 308, and possibly one or more other validators 310 for validating a metadata-as-code file 301.

For example, the security classification validator 302 can be configured to evaluate whether the metadata-as-code file 301 adheres to designated security standards for ensuring that the corresponding data asset complies with one or more security policies. As an example, the security classification validator 302 can evaluate whether the metadata-as-code file 301 is associated with data corresponding to payment card industry (PCI) data, personally identifiable information (PII) data, public data, internal data, restricted data and/or highly restricted data.

The architecture standard validator 304 verifies that the metadata-as-code file 301 conforms to established architectural guidelines for promoting consistency across different environments within the organization. For example, the architecture standard validator 304 can determine whether one or more application programming interfaces (APIs) are aligned with designated API standards.

The data model validator 306 ensures that the metadata-as-code file 301 aligns with one or more designated data models relating to how the data asset is structured and used. For example, the data model validator 306 can determine whether a model of a corresponding data asset is aligned with a designated information model (e.g., an enterprise information model).

The data quality rule validator 308 assesses whether the metadata-as-code file 301 satisfies defined data quality rules, such as completeness, accuracy and consistency checks prior to deployment.

Additionally, one or more other validators 310 may be included to address specific governance needs or to support additional policies and/or rules relevant to a particular organization. For example, one or more users can define rules for a specific data asset.

In some embodiments, each validator in the data pipeline 300 outputs a result indicating whether the metadata-as-code file 301 satisfies its respective criteria. In at least one embodiment, at least some of the validators can be configured to output a binary value indicating whether or not the corresponding criteria are satisfied. For example, the security classification validator 302 can be configured to output a first value (e.g., 0) if the security classification criteria is satisfied and a second value if the security classification is not satisfied.

In at least some embodiments, at least one of the validators of the data pipeline 300 can be configured to output a score within a designated range (e.g., between 0-100), where the score indicates a level of compliance with the corresponding criteria. As a non-limiting example, the data quality rule validator 308 can determine multiple scores for different data quality categories (such as completeness, accuracy and consistency), which are then combined (e.g., summed) to determine a total score. Optionally, the data quality categories can be weighted differently depending on the use case. The score output by each of the validators can be compiled into one or more pipeline metrics 312, which can provide an aggregated assessment of how well the metadata-as-code file 301 complies with the overall governance framework. As a non-limiting example, the score output by each validator in the data pipeline 300 can be normalized and combined to provide an aggregated score indicating an overall level of compliance with the governance framework.

If the validators pass their checks successfully, the metadata-as-code file 301 is considered validated and can proceed to further deployment steps, as described elsewhere herein. In some embodiments, each validator in the data pipeline 300 can be configured with a corresponding threshold. For the metadata-as-code file 301 to be validated, the score corresponding to each of the validators must satisfy its corresponding threshold. Alternatively, or additionally, the aggregated score can be configured with a threshold.

It is to be appreciated that some of the validators in the data pipeline 300 can validate the metadata-as-code file 301 directly (e.g., without needing access to the underlying data asset). For example, consider a situation where the data quality rule validator 306 is configured with a rule that requires a designated quality score in order to validate the metadata-as-code file 301. In at least some examples, the quality score can be included as part of the metadata in the metadata-as-code file 301, in which case the data quality rule validator 306 can apply the rule based on the quality score. If the metadata-as-code file 301 does not include the quality score or it is missing, then the validation for the data quality rule validator 306 for the metadata-as-code file 301 may fail. Alternatively, the data quality rule validator 306 may be configured to automatically initiate a data quality analysis on the underlying data asset to obtain the quality score.

It is to be appreciated that the data pipeline 300 comprises a modular design that enables flexibility in adding, removing or modifying validators as organizational needs evolve.

FIG. 4 shows an example of a metadata-as-code file 400 in an illustrative embodiment. The metadata-as-code file 400 is structured to include information related to characteristics and attributes of a given data asset, such as a data product, in a machine-readable format.

The metadata-as-code file 400 includes various fields that describe different aspects of the data asset. The metadata-as-code file 400 includes an identifier (“01”) and a name of the data asset (“Data Product Sample”) and other metadata (e.g., attributes and details) related to the data asset. In this example, the metadata include a short description and a long description of the data product; a version number; Service Level Agreement (SLA) requirements (e.g., availability); lifecycle rules specifying how long the data should be retained before it can be archived or deleted; domain owner information; data object reference information for referencing specific data objects (e.g., tables) that are part of, or related to, the data product; related data product information; a data model link for providing a link to a detailed data model document for the data asset; and documentation to relevant documents about the data product. The metadata-as-code file 400 also indicates the creation tool used to generate or manage the metadata-as-code file 400, the date and time when the metadata-as-code file was created and a ticket identifier for a ticket related to the data product, which may be linked to a version management system, for example.

It is to be appreciated that the particular example shown in FIG. 4 shows just one example implementation of a metadata-as-code file, and alternative implementations of the metadata-as-code file can be used in other embodiments.

FIG. 5 is a flow diagram of a process for computational governance using metadata-as-code in an illustrative embodiment. It is to be understood that this particular process is only an example, and additional or alternative processes can be carried out in other embodiments.

In this embodiment, the process includes steps 500 through 504. These steps are assumed to be performed by the metadata validation system 105 utilizing its elements 112, 114, 116 and 118.

Step 500 includes obtaining metadata in a code format for at least one data asset, wherein the metadata comprises information related to one or more characteristics of the at least one data asset.

Step 502 includes processing the obtained metadata using at least one data pipeline, wherein the at least one data pipeline executes at least one validation process for automatically validating the obtained metadata based on one or more data validation rules.

Step 504 includes automatically deploying, based at least in part on the code format, the obtained metadata to at least one computing environment in response to at least one designated result of the at least one validation process.

The process may further include managing multiple versions of the obtained metadata in the code format using at least one version management tool.

The process may further include selecting one of the multiple versions of the obtained metadata in the code format to be used for the automatically deploying the obtained metadata to the at least one computing environment.

The process may further include managing the automatic deployment of the selected version of the obtained metadata to the at least one computing environment using a continuous integration/continuous deployment platform.

The process may further include re-executing the at least one data pipeline to at least one of: (i) redeploy the obtained metadata to the at least one computing environment and (ii) deploy the obtained metadata to one or more additional computing environments.

The computing environment may be associated with at least one data catalog, and the automatically deploying may include converting the obtained metadata in the code format to a format corresponding to the at least one data catalog.

The process may further include storing the obtained metadata in at least one of a data catalog and an artifact library in the code format.

The obtained metadata may be stored in the code format separately from the at least one data asset.

The data catalog may provide access to the at least one data asset, and the obtained metadata may provide descriptive information about the at least one data asset.

The one or more data validation rules may include at least one data governance rule corresponding to at least one of a security classification, one or more system architecture standards, a data quality, lineage information and ownership information.

The automatically deploying may be performed in response to an approval from at least one user.

The at least one validation process may include processing the obtained metadata based on the code format and outputting at least one score indicating a level that the obtained metadata complies with at least one of the one or more data validation rules.

The obtained metadata may be automatically deployed in response to the at least one score satisfying at least one corresponding threshold.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments leverage metadata-as-code in conjunction with data pipelines and validators to automate the governance process, enabling organizations to achieve computational governance at scale and speed while ensuring consistency across different environments. Such embodiments can effectively address the inefficiencies of existing techniques that are not suitable for handling large volumes of data and lack the ability to enforce consistent standards in both federated and centralized governance models. Additionally, some embodiments can effectively alleviate bottlenecks commonly encountered in traditional centralized governance approaches by using a structured code format for metadata that can be automatically processed and validated using one or more data pipelines.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

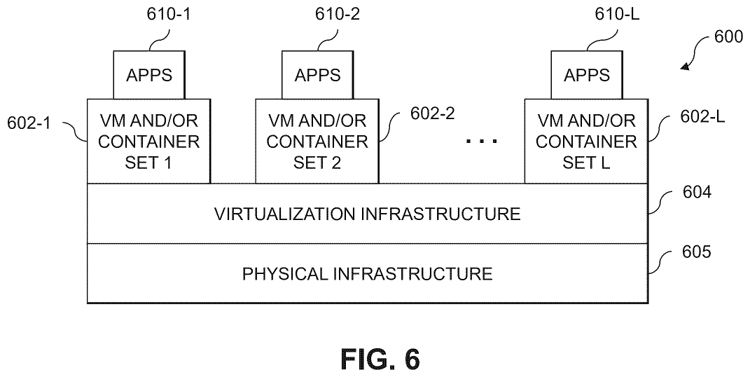

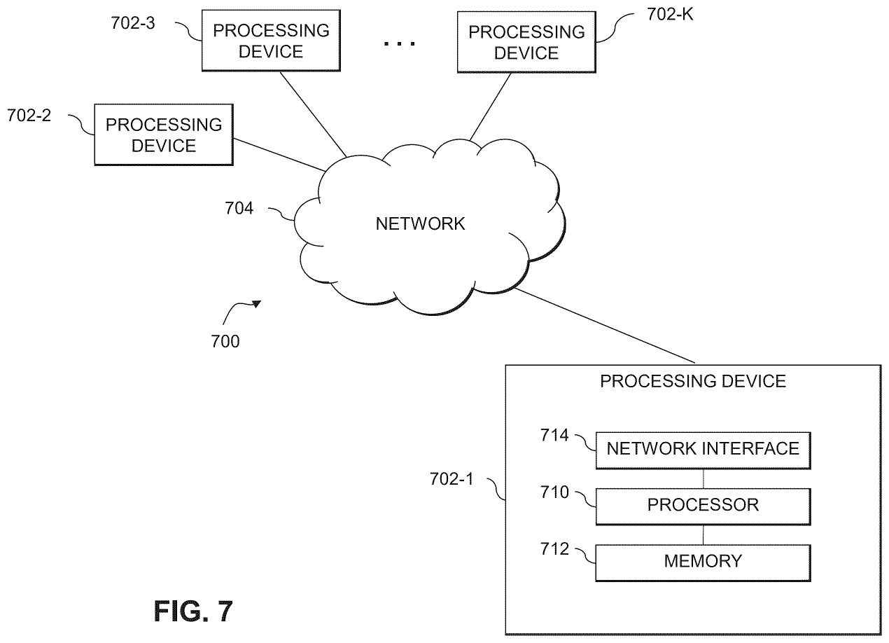

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2,. 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2,. 610-L running on respective ones of the VMs/container sets 602-1, 602-2,. 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an ASIC, an FPGA, a CPU, a GPU, a TPU, a VPU, an NPU, a DPU, a SOC or other type of processing circuitry, as well as portions or combinations of such circuitry elements.

The memory 712 comprises RAM, ROM or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed computing environment in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining metadata in a code format for at least one data asset, wherein the metadata comprises information related to one or more characteristics of the at least one data asset;
processing the obtained metadata using at least one data pipeline, wherein the at least one data pipeline executes at least one validation process for automatically validating the obtained metadata based on one or more data validation rules; and
automatically deploying, based at least in part on the code format, the obtained metadata to at least one computing environment in response to at least one designated result of the at least one validation process;
wherein the method is performed by at least one processing device comprising a processor coupled to a memory.

2. The computer-implemented method of claim 1, further comprising:
managing multiple versions of the obtained metadata in the code format using at least one version management tool.

3. The computer-implemented method of claim 2, further comprising:
selecting one of the multiple versions of the obtained metadata in the code format to be used for the automatically deploying the obtained metadata to the at least one computing environment.

4. The computer-implemented method of claim 3, further comprising:
managing the automatic deployment of the selected version of the obtained metadata to the at least one computing environment using a continuous integration/continuous deployment platform.

5. The computer-implemented method of claim 2, further comprising:
re-executing the at least one data pipeline to at least one of: (i) redeploy the obtained metadata to the at least one computing environment and (ii) deploy the obtained metadata to one or more additional computing environments.

6. The computer-implemented method of claim 1, wherein:
the computing environment is associated with at least one data catalog; and
the automatically deploying comprises converting the obtained metadata in the code format to a format corresponding to the at least one data catalog.

7. The computer-implemented method of claim 1, further comprising:
storing the obtained metadata in at least one of a data catalog and an artifact library in the code format.

8. The computer-implemented method of claim 7, wherein the obtained metadata is stored in the code format separately from the at least one data asset.

9. The computer-implemented method of claim 7, wherein:
the data catalog provides access to the at least one data asset; and
the obtained metadata provides descriptive information about the at least one data asset.

10. The computer-implemented method of claim 1, wherein the one or more data validation rules comprise at least one data governance rule corresponding to at least one of:
a security classification;
one or more system architecture standards;
a data quality;
lineage information; and
ownership information.

11. The computer-implemented method of claim 1, wherein the automatically deploying is performed in response to an approval from at least one user.

12. The computer-implemented method of claim 1, wherein the at least one validation process comprises:
processing the obtained metadata based on the code format; and
outputting at least one score indicating a level that the obtained metadata complies with at least one of the one or more data validation rules.

13. The computer-implemented method of claim 12, wherein the obtained metadata is automatically deployed in response to the at least one score satisfying at least one corresponding threshold.

14. A non-transitory processor-readable storage medium having stored therein program code of one or more software programs, wherein the program code when executed by at least one processing device causes the at least one processing device:
to obtain metadata in a code format for at least one data asset, wherein the metadata comprises information related to one or more characteristics of the at least one data asset;
to process the obtained metadata using at least one data pipeline, wherein the at least one data pipeline executes at least one validation process for automatically validating the obtained metadata based on one or more data validation rules; and
to automatically deploy, based at least in part on the code format, the obtained metadata to at least one computing environment in response to at least one designated result of the at least one validation process.

15. The non-transitory processor-readable storage medium of claim 14, wherein the program code, when executed by the at least one processing device, further causes the at least one processing device:
to manage multiple versions of the obtained metadata in the code format using at least one version management tool.

16. The non-transitory processor-readable storage medium of claim 15, wherein the program code, when executed by the at least one processing device, further causes the at least one processing device:
to select one of the multiple versions of the obtained metadata in the code format to be used for the automatically deploying the obtained metadata to the at least one computing environment.

17. The non-transitory processor-readable storage medium of claim 16, wherein the program code, when executed by the at least one processing device, further causes the at least one processing device:
to manage the automatic deployment of the selected version of the obtained metadata to the at least one computing environment using a continuous integration/continuous deployment platform.

18. An apparatus comprising:
at least one processing device comprising a processor coupled to a memory;
the at least one processing device being configured:
to obtain metadata in a code format for at least one data asset, wherein the metadata comprises information related to one or more characteristics of the at least one data asset;
to process the obtained metadata using at least one data pipeline, wherein the at least one data pipeline executes at least one validation process for automatically validating the obtained metadata based on one or more data validation rules; and
to automatically deploy, based at least in part on the code format, the obtained metadata to at least one computing environment in response to at least one designated result of the at least one validation process.

19. The apparatus of claim 18, wherein the at least one processing device is further configured:
to manage multiple versions of the obtained metadata in the code format using at least one version management tool.

20. The apparatus of claim 19, wherein the at least one processing device is further configured:
to select one of the multiple versions of the obtained metadata in the code format to be used for the automatically deploying the obtained metadata to the at least one computing environment.
